(19) United States
(12) Patent Application Publication
(10) Pub. No.: US 2003/0164602 A1
(43) Pub. Date: Sep. 4, 2003

(54) Table cart

(76) Inventor: Thomas E. Kuhlman, Spirit Lake, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 10/090,606

(22) Filed: Mar. 4, 2002

(51) Int. Cl. B62B 3/10

(52) U.S. Cl. 280/79.7

(57) ABSTRACT

A cart frame having a bottom frame member, a top frame member, support struts connecting the bottom frame member and the top frame member, and caster wheels attached to the bottom frame member. The top frame member has a higher positioned opened front side and a lower positioned back supported rear side. The open front side may be inserted under upright collapsible tables with the table tilted up easily by a single person so that they will slide back and are then supported against the rear side's support back.

### FIELD OF THE INVENTION

The present invention relates to a table cart specially designed for setting up, taking down and moving foldable tables, all by a single person.

### BACKGROUND OF THE INVENTION

Folding tables are, of course, well known, usually of standardized height of from about 23 inches to 30 inches. Typically, two sets of folding legs are attached to the bottom surface of a planar platform, with the table having an upright, use position, and a collapsed rest position. At rest, the legs rest adjacent the bottom side surface of the table platform.

Folding tables of the type above described are commonly used in hotels, motels, convention centers, schools and the like. Such tables usually are stored folded, collapsed, and stacked. When needed for convention meetings, conferences, etc., the tables are moved from storage to the area for use, unstacked, the legs raised and the tables set up.

This job of transporting collapsing and setting up such tables commonly involves several people and almost always a minimum of two. One of the reasons at least two people are required is because of the awkwardness of handling most collapsible tables which often run anywhere from 60 inches to 96 inches in length. The large size, therefore, necessitates two or more people for handling.

There have been many prior art table caddies before. Examples include table dollies or racks, see for example U.S. Pat. No. 5,871,219; U.S. Pat. No. 2,687,310, and U.S. Pat. No. 2,945,699. None address the specific object of allowing a single person to load and unload collapsible tables all without having to do significant lifting. This, of course, is a worthy objective in that it allows the most efficient uses of manpower, and the lack of the usually required individual lifting would increase worker safety and decrease injury risk.

In summary, although there have been table caddies or table dollies before, none are of a design configuration that allows one-person operation with the person not having to engage in substantial lifting. The primary objective of the present invention is to fulfill the above need with a table cart that can be maneuvered, used and stored all by a single operator with minimum lifting and which at the same time has no moving parts, further decreasing injury risk.

### SUMMARY OF THE INVENTION

A cart frame having a bottom frame member, a top frame member, support struts connecting the bottom frame member and the top frame member, with caster wheels attached to the bottom frame member. The top frame member has an elevated position opened front side which slants back to a lower positioned back, which provides rear table support. The open front side may be inserted under upright tables with the table tilted up easily by a single person so that it slides back and down. It is then supported against the rear side's table support back.

### BRIEF DESCRIPTION OF THE DRAWINGS

FIG. 1 is a perspective view of the table cart unloaded.

FIG. 2 is a perspective view from the same perspective as FIG. 1 with a table cart loaded.

FIG. 3 is a perspective view of the table cart from the handle side, unloaded.

FIG. 4 is an end view from the end opposite the handle end with the cart unloaded.

### DETAILED DESCRIPTION OF A PREFERRED EMBODIMENT

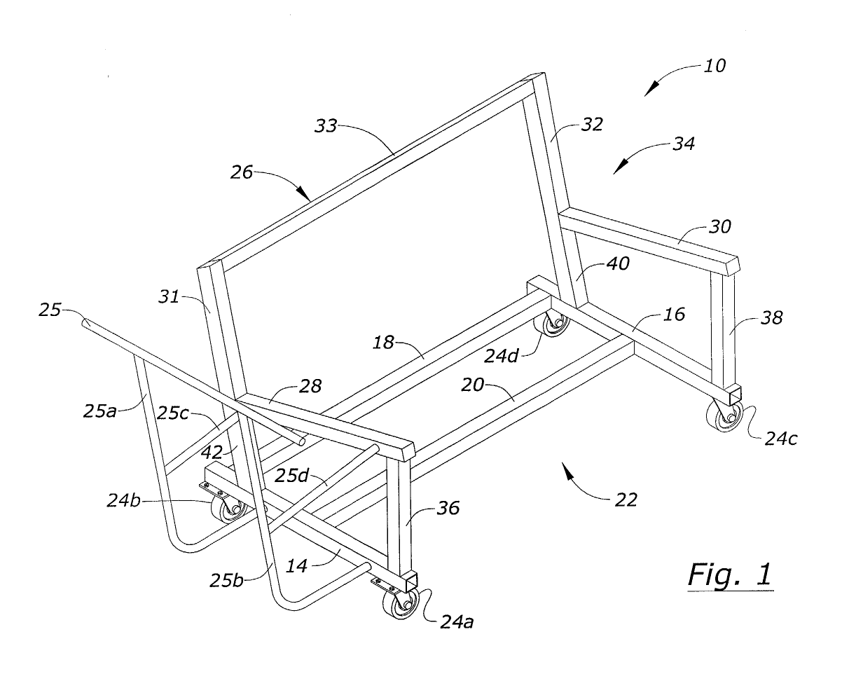

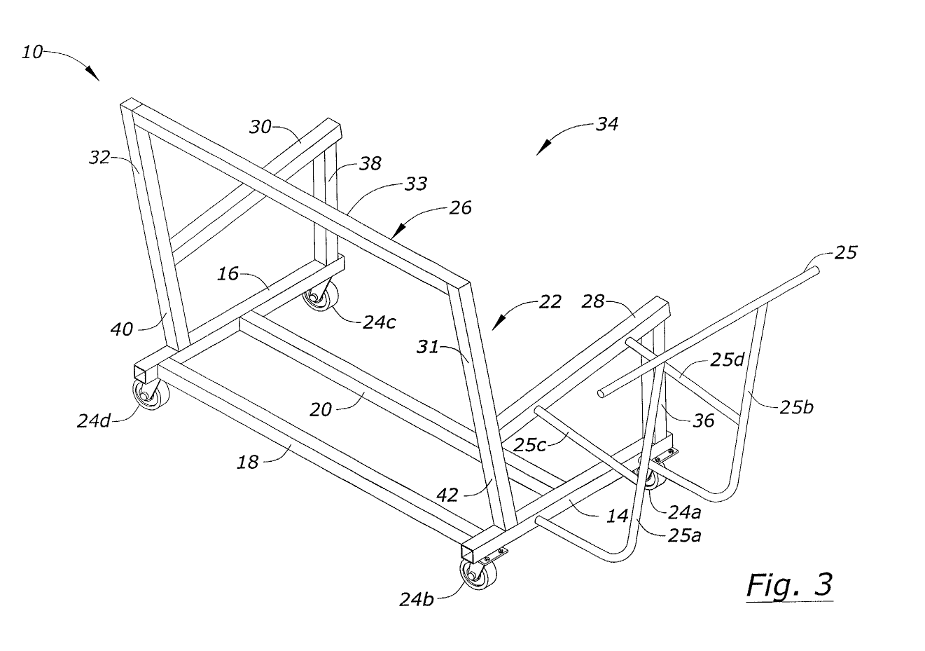

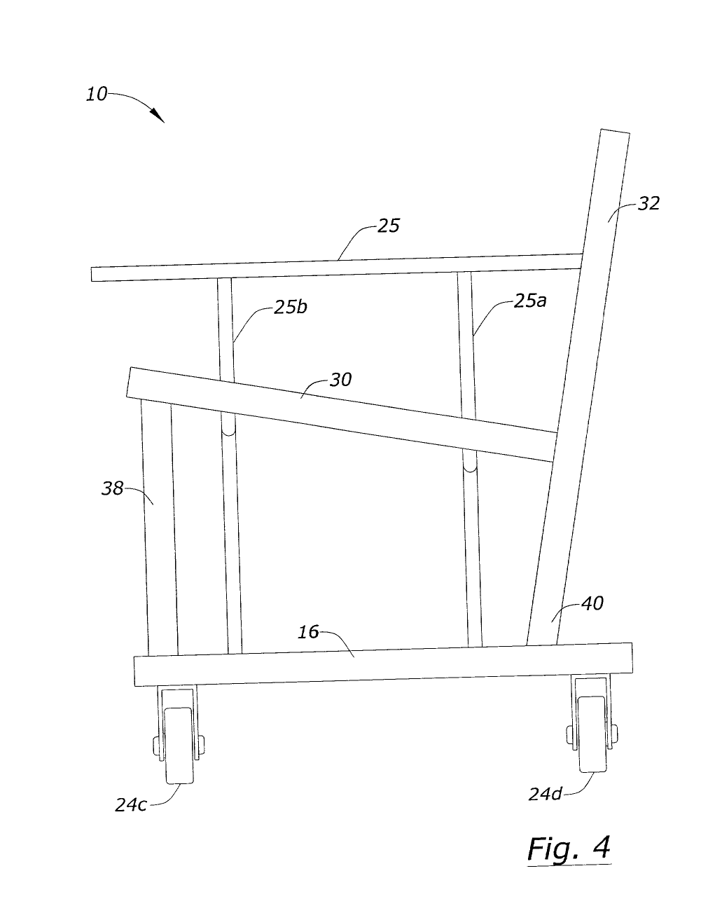

With continuing reference to FIGS. 1 through 4 of the drawings, table cart 10 will be described. The cart 10 has a bottom frame 12 defined by spaced apart side bars 14 and 16 joined by rear side 18 and mid-brace 20 with the bottom frame defining an open front 22. Attached to the bottom frame under side bars 14 and 16 are caster wheels 24(a), (b), (c), and (d). 24(a) and 24(b) are swivel casters and 24(c) and 24(d) are fixed axle casters. Attached to side bar 18 is handle 25 with its own support braces 25(a), (b), (c) and (d).

Above the bottom frame 12 is a top frame 26 defined by side bars 28, 30, rear bars 31 and 32 and back bar 33. The bottom frame portion 12 and top frame portions have open fronts. Supporting and joining top frame 26 and bottom frame 12, are front struts 36 and 38 and rear struts 40 and 42. As seen, rear struts 40 and 42 are longer than front struts 36 and 38 and extend up to back bar 33. From the open front of the top frame portion 34 to rear bars 31, 32, side bars 28, 30 angle downwardly to where they join the side bars. The angle is generally rearwardly and downwardly to allow use without the need for lifting of tables as described below. Depending on the height of front struts 36 and 38, and the location where rear struts 40 and 42, are joined to side bars 28, 30, the angle downwardly can vary between 5° and 20°, but preferably is between 10° and 15° and most preferably is 10°. The height of front struts 36 and 38 will vary depending upon the height of the tables, and could even be optionally adjustable, if one desired. Normally, however, they are of a fixed length. Typically folding tables have heights from 23 inches to 30 inches and front struts 36 and 38 are of a height that they just fit under top surface of an upright folding table. The unit thus has no moving parts, which increases safety.

Certain constructional features are worthy of some mention. The cart can be made of square tubing steel and typically two-inch square tubing has been found satisfactory, and preferred. For ease of operation, it is preferred that the caster wheels adjacent handle 25 are swivel casters and that those on the opposing end are fixed axle casters. This, however, could be altered if desired. The preferred system allows easier steering by a single person. The stock or tubing could be round if desired and the unit could be adapted to round tables, if one wished.

Top frame side bars 28 and 30 may be a length of about 30 inches which will conveniently allow stacking of about 12 tables.

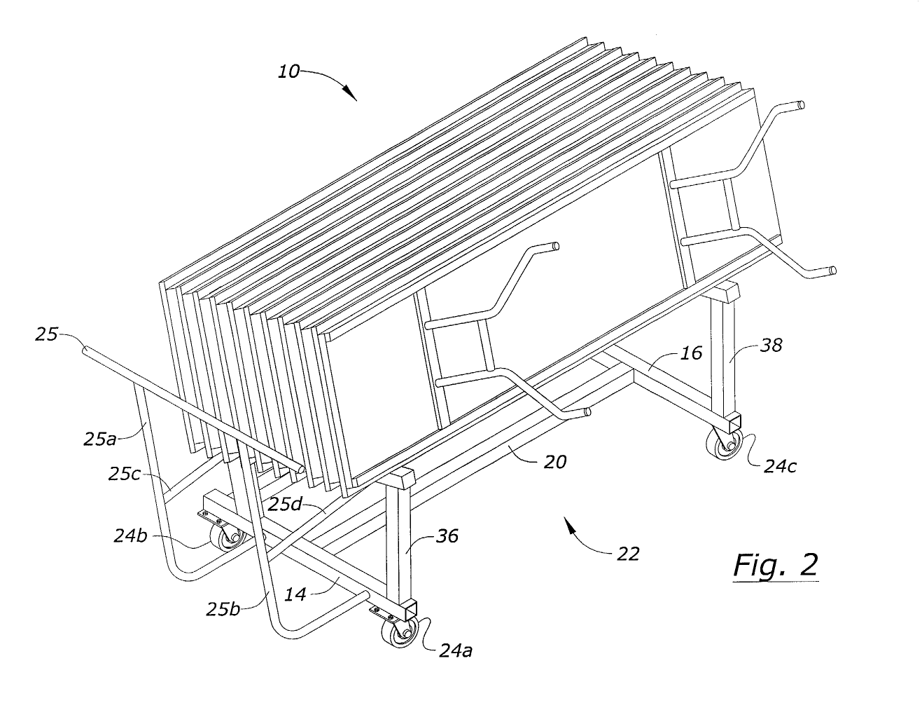

In actual operation, the unit works in the following manner (assuming tables are set up and are being taken down). The cart 10 is maneuvered into position such that the forward ends of side bars 28 and 30 are positioned under an upright table's top surface. The table is then grabbed from its opposite side and tipped up to a position as shown in FIG. 2. The table easily pivots up on side bars 28 and 30 and slides against rear bars 31, 32 and back bar 33. The legs are then collapsed and the table rests against the rear back support. Other tables can be loaded in the same manner. The tables can be stacked along the full length of side bars 28 and 30 and then moved to a storage place. For unstacking, one simply reverses the process putting the legs in the down position of FIG. 2 and then grabbing either the legs or the table and tilting it down. The weight bearing load of the table is always on the pivot point on struts 28 and 30, not on the operator. Moreover, a single person can accomplish the entire load and unload and transport system. It, therefore, can be seen that the invention accomplishes all of its stated objectives.

What is claimed is:

1. A cart frame having a bottom frame member, a top frame member, support struts connecting the bottom frame member and the top frame member and caster wheels attached to said bottom frame member;
said top frame member having a front and higher positioned open side and a lower and rear positioned side, and a table support attached to said lower and rear positioned side.

2. The table cart of claim 1 wherein the higher positioned front side of said top member extends downwardly to the lower positioned rear side at an angle of from 5° to 20°.

3. The table cart of claim 1 wherein the higher positioned front side of said top member extends downwardly to the lower positioned rear side at an angle of from 10° to 15°.

4. The table cart of claim 1 wherein the higher positioned front side of said top member extends downwardly to the lower positioned rear side at an angle of from 10°.

5. The table cart of claim 1 wherein the higher positioned front side of said table is just tall enough to slide under the top surface of an upright folding table.

6. The table cart of claim 1 wherein the cart is made of square tubing steel.

7. The table cart of claim 6 wherein the cart is made of 2 inch square tubing steel.

8. The table cart of claim 1 which has a pull handle attached one side of said table.

9. The table cart of claim 8 wherein the caster wheels attached to the bottom frame member, closest to the pull handle are swivel carts and the others are fixed angle casters.

10. The method of loading folding tables on a table cart comprising;
positioning a table cart with its forward top under the surface of a collapsible upright folding table tipping the table up onto the forward top and sliding said table downwardly and rearwardly until it rests against a back support;
collapsing the exposed table legs; and
thereafter repeating the process until the cart is loaded with stacked, collapsed leg tables; and then transporting the tables to a desired location.
